(19) United States
(12) Patent Application Publication
(10) Pub. No.: US 2009/0142479 A1
(43) Pub. Date: Jun. 4, 2009

(54) Method of Manufacturing Semiconductor Device-Fabrication Wafer Holder

(75) Inventors: Masuhiro Natsuhara, Itami-shi (JP); Hirohiko Nakata, Itami-shi (JP); Manabu Hashikura, Itami-shi (JP)

Correspondence Address: Judge Patent Associates, Dojima Building, 5th Floor, 6-8 Nishitemma 2-Chome, Kita-ku, Osaka-Shi, 530-0047, JP

(73) Assignee: SUMITOMO ELECTRIC INDUSTRIES, LTD., Osaka-shi (JP)

(21) Appl. No.: 12/367,558

(22) Filed: Feb. 9, 2009

Related U.S. Application Data
(62) Division of application No. 10/604,514, filed on Jul. 28, 2003, now abandoned.

(30) Foreign Application Priority Data
Mar. 24, 2003 (JP) 2003-079324

(51) Int. Cl. B05D 3/12

(52) U.S. Cl. 427/98.5

(57) ABSTRACT

Wafer holder and semiconductor manufacturing equipment in which the holder is installed, the wafer holder having a wafer-carrying surface, wherein incidence of warping and cracking when the wafer holder is heated is slight. In the wafer holder having a wafer-carrying surface, electrical circuitry consisting of one or more sinter laminae is formed on the face or in the interior of the wafer holder; and by rendering pores present in the circuitry, the incidence of warping and cracking can be made very slight. The electrical circuitry is preferably any of an electrode circuit for an electrostatic chuck, a resistive-heating-element circuit, an RF-power electrode circuit, and a high-voltage-generating electrode circuit.

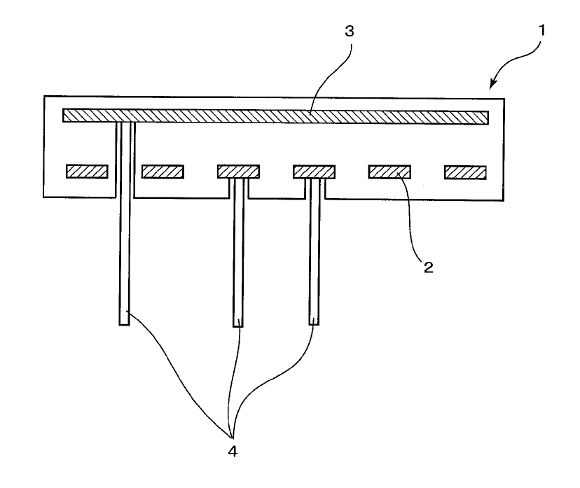

### BACKGROUND OF THE INVENTION

1. Technical Field

The present invention relates to wafer holders employed in semiconductor manufacturing devices such as plasma-assisted CVD, low-pressure CVD, metal CVD, dielectric-film CVD, ion-implantation, etching, low-k film heat treatment, and degassing heat treatment device, and furthermore to process chambers and semiconductor manufacturing devices in which the wafer holders are installed.

2. Description of the Related Art

Conventionally, in semiconductor manufacturing procedures various processes such as film deposition processes and etching processes are carried out on semiconductor substrates that are the processed objects. Ceramic susceptors that retain such semiconductor substrates in order to heat them are used in the processing devices in which the processes on the semiconductor substrates are carried out.

Japanese Pat. App. Pub. No. H04-78138 for example discloses a conventional ceramic susceptor of this sort. The ceramic susceptor includes: a heater part made of ceramic, into which a resistive heating element is embedded and that is provided with a wafer-heating surface, arranged within a chamber; a columnar support part that is provided on a surface apart from the wafer-heating surface of the heating section and that forms a gastight seal between it and the chamber; and electrodes connected to the resistive heating element and leading outside the chamber so as essentially not to be exposed to the chamber interior space.

Although the invention serves to remedy the contamination and poor thermal efficiency that had been seen with heaters made of metal—heaters prior to the invention—it does not touch upon warping of or cracking in ceramic susceptors. Wafers are processed at high temperatures in semiconductor manufacturing equipment, however, which means that the ceramic susceptors are heated to high temperatures. Given the circumstances, a problem has been that warping in the ceramic susceptor, arising in the thermal characteristics of its electrical circuitry, will occur, leading to breaches in between the wafer and the wafer-retaining face and making it improbable that the temperature of the wafer face will be uniform. Should the temperature of the wafer face turn out to be non-uniform, in situations where a film-deposition process is performed, irregularities in the thickness and quality of the thin film formed on the wafer face will appear; in situations in which an etching process is carried out, trouble such as fluctuations in the etching speed will occur.

In this regard, Japanese Pat. App. Pub. No. 2001-302330 discloses a technique for resolving the problems of warping and cracking in ceramic substrates. The invention has it that by strictly controlling the thickness of both the ceramic substrate and the electrical circuitry, warping and cracking in the ceramic substrate can be prevented. Nevertheless, with strict control of the thickness of the ceramic substrate and the electrical circuitry layer meaning higher costs, it has been difficult to realize inexpensive ceramic susceptors. As to electrical circuits, moreover, there are various kinds; and depending on what they are targeted for, there are various circuit patterns. For example, with resistive heating element circuits, the configuration would be a coil; with RF electrode circuits, the configuration would be a continuous single-ply sheet. Thus, wherein a plurality of electrical circuits that differ in configuration is formed on the face and in the interior of the wafer holder, on account of their configurations, the respective circuits will give rise to differences in the extent to which they cause the wafer holder to expand thermally.

By the same token, a difference in extent of thermal expansion also arises between the circuits and the wafer-holder ceramic, since there is a difference between them in thermal expansion coefficient. The result is that internal stress caused by the differences in degree of thermal expansion is produced in the wafer holder, giving rise to warping and cracking. With methods as in Japanese Pat. App. Pub. No. 2001-302330 of strictly controlling the thickness of the ceramic substrate and the electrical circuitry, in cases where as just mentioned several electrical circuits are fashioned in a wafer holder, costs end up going even higher.

None of these publications discusses the porosity of heating circuits embedded in ceramic susceptors, nor, moreover, the effect that heating-circuit porosity might have on warping and cracking of susceptors. U.S. Pat. Pub. No. 2002/0007911, meanwhile, discusses the printing formation of electroconductive layers in wafer holders, but is silent as to how, or even whether, porosity might be controlled in the process of forming such layers.

### BRIEF SUMMARY OF THE INVENTION

The present invention has been brought about to address the foregoing issues. In particular, an object of the present invention is to realize for semiconductor manufacturing equipment a wafer holder in which incidence of warping and cracking is slight when heated to high temperatures, and semiconductor manufacturing equipment in which the wafer holder is installed.

In a wafer holder having a wafer-carrying surface according to the present invention, an electrical circuit layer consisting of one or more sinter laminae is formed on the face or in the interior of the wafer holder, which is characterized in that pores are present in the circuit layer. It is preferable that the main constituent of the circuit layer be one or more metals selected from tungsten, molybdenum and tantalum, and that the porosity thereof be 0.1% or more. It is alternatively preferable that the main constituent of the circuit layer be one or more metals selected from silver, vanadium and platinum, and that the porosity thereof be 2% or more.

Also preferable is that the electrical circuitry be any one, or a plurality, of: an electrode circuit for an electrostatic chuck, a resistive-heating-element circuit, an RF-power electrode circuit, and a high-voltage-generating electrode circuit; more preferable is that the circuitry include at least a resistive-heating-element circuit.

In a semiconductor manufacturing device in which a wafer holder as in the foregoing is installed, inasmuch as incidence of warping and cracking in the wafer holder is slight, the temperature of a wafer that is being processed proves to be more uniform than what has been conventional, making for better-throughput manufacturing of semiconductors.

From the following detailed description in conjunction with the accompanying drawings, the foregoing and other objects, features, aspects and advantages of the present invention will become readily apparent to those skilled in the art.

### BRIEF DESCRIPTION OF THE SEVERAL VIEWS OF THE DRAWINGS

The FIGURE illustrates one example of the sectional structure of a wafer holder according to the present invention.

### DETAILED DESCRIPTION OF THE INVENTION

The present inventors discovered that imparting pores in electrical circuitry made of a sinter, formed on the face or in the interior of the wafer holder, and controlling the porosity thereof makes for preventing warping and cracking in the wafer holder.

The electrical circuitry may be circuits such as an electrostatic-chuck electrode circuit for electrostatically chucking wafers, a resistive-heating-element circuit (heater circuit) for heating the wafer holder, or an RF electrode circuit for generating plasma, and furthermore may be a high-voltage circuit for ion-beam irradiation. While the circuitry preferably is equipped at least with a resistive-heating-element circuit, it may be equipped with a resistive-heating-element circuit and at the same time another circuit—for example, so as to be equipped with a resistive-heating-element circuit 2 and an RF electrode circuit 3 as illustrated in the FIGURE.

Conventionally it has been maintained that the more densified the circuitry, formed by calcining an ordinary metal powder, the better it is. On the contrary, it was discovered that imparting pores (or bubbles, voids, cavities, etc.) to the circuitry is effective for absorbing the aforementioned differences in degree of thermal expansion to prevent warping and cracking in the wafer holder.

In particular, if the circuitry is the usual densified material, when it has expanded thermally internal stress will be produced, and warping will arise, by just that difference with the ceramic in the extent of its thermal expansion. If, however, pores are present in the circuitry, the pores presumably absorb the difference in thermal expansion, mitigating the internal stress. Mitigating the internal stress would be what can prevent the occurrence of warping. It will be realized that the occurrence of warping can be prevented inasmuch as the internal stress is mitigated.

Wherein the main constituent of the circuitry is made one or more metals selected from tungsten, molybdenum and tantalum, the porosity should be 0.1% or more. Likewise, wherein the main constituent of the circuitry is made one or more metals selected from silver, vanadium and platinum, the porosity should be 2% or more.

That a difference in porosity will appear depending on what the metal substance is in the circuitry reflects the disparity in how great the difference between the thermal expansion coefficient of the metal and of the ceramic is. Wherein the main constituent is made tungsten, molybdenum and tantalum, whose differences in thermal expansion coefficient with ceramics are slight, the effects described above will be brought out if the porosity is at least 0.1%. Wherein the main constituent of the circuitry is made one or more metals selected from silver, vanadium and platinum, whose differences in thermal expansion coefficient with ceramics are great, if the porosity is not made a considerable 2% or more, the effects will not appear.

While the effects according to the present invention can be gained if the porosity is a predetermined amount as just stated or greater, since the electrical resistance of the circuitry will become too high if the porosity is too large, it should be made some 40% or less.

Insofar as the substances for a wafer holder according to the present invention are insulative ceramics, they are not particularly restricted, but aluminum nitride (AlN) is preferable for its high thermal conductivity and superior corrosion resistance. In the following, a method according to the present invention of manufacturing a wafer holder in a AlN instance will be described in detail.

An AlN raw-material powder whose specific surface area is 2.0 to 5.0 m²/g is preferable. The sinterability of the aluminum nitride declines if the specific surface area is less than 2.0 m²/g. Handling proves to be a problem if on the other hand the specific surface area is over 5.0 m²/g, because the powder coherence becomes extremely strong. Furthermore, the quantity of oxygen contained in the raw-material powder is preferably 2 wt. % or less. In sintered form, its thermal conductivity deteriorates if the oxygen quantity is in excess of 2 wt. %. It is also preferable that the amount of metal impurities contained in the raw-material powder other than aluminum be 2000 ppm or less. The thermal conductivity of the powder in sintered form deteriorates if the amount of metal impurities exceeds this range. In particular, the content respectively of Group IV elements such as Si, and elements of the iron family, such as Fe, which have a serious worsening effect on the thermal conductivity of the sinter, is advisably 500 ppm or less.

Because AlN is not a readily sinterable material, adding a sintering promoter to the AlN raw-material powder is advisable. The sintering promoter added preferably is a rare-earth element compound. Since rare-earth element compounds react with aluminum oxides or aluminum oxynitrides present on the surface of the particles of the aluminum nitride powder, acting to promote densification of the aluminum nitride and to eliminate oxygen being a causative factor that worsens the thermal conductivity of an aluminum nitride sinter, they enable the thermal conductivity of aluminum sinters to be improved.

Yttrium compounds, whose oxygen-eliminating action is particularly pronounced, are preferable rare-earth element compounds. The amount added is preferably 0.01 to 5 wt. %. If less than 0.01 wt. %, producing ultrafine sinters is problematic, along with which the thermal conductivity of the sinters deteriorates. Added amounts in excess of 5 wt. % on the other hand lead to sintering promoter being present at the grain boundaries in an aluminum nitride sinter, and consequently, if the aluminum nitride sinter is employed under a corrosive atmosphere, the sintering promoter present along the grain boundaries gets etched, becoming a source of loosened grains and particles. More preferably the amount of sintering promoter added is 1 wt. % or less. If less than 1 wt. % sintering promoter will no longer be present even at the grain boundary triple points, which improves the corrosion resistance.

To characterize the rare-earth compounds further: oxides, nitrides, fluorides, and stearic oxide compounds may be employed. Among these oxides, being inexpensive and readily obtainable, are preferable. By the same token, stearic oxide compounds are especially suitable since they have a high affinity for organic solvents, and if the aluminum nitride raw-material powder, sintering promoter, etc. are to be mixed together in an organic solvent, the fact that the sintering promoter is a stearic oxide compound will heighten the miscibility.

Next, the aluminum nitride raw-material powder, sintering promoter as a powder, a predetermined volume of solvent, a binder, and further, a dispersing agent or a coalescing agent added as needed, are mixed together. Possible mixing techniques include ball-mill mixing and mixing by ultrasound. Mixing can thus produce a raw material slurry.

The obtained slurry can be molded, and by sintering the molded product, an aluminum nitride sinter can be produced. Co-firing and post-metallization are two possible methods as a way of doing this.

Post-metallization will be described first. Granules are prepared from the slurry by means of a technique such as spray-drying. The granules are inserted into a predetermined mold and subject to press-molding. The pressing pressure therein desirably is 0.1 t/cm² or more. With pressure less than 0.1 t/cm², in most cases sufficient strength in the molded mass cannot be produced, making it liable to break in handling.

Although the density of the molded mass will differ depending on the amount of binder contained and on the amount of sintering promoter added, preferably it is 1.5 g/cm³ or more. Densities less than 1.5 g/cm³ would mean a relatively large distance between particles in the raw-material powder, which would hinder the progress of the sintering. At the same time, the molded mass density preferably is 2.5 g/cm³ or less. Densities of more than 2.5 g/cm³ would make it difficult to eliminate sufficiently the binder from within the molded mass in a degreasing process of a subsequent step. It would consequently prove difficult to produce an ultrafine sinter as described earlier.

Next, heating and degreasing processes are carried out on the molded mass within a non-oxidizing atmosphere. Carrying out the degreasing process under an oxidizing atmosphere such as air would degrade the thermal conductivity of the sinter, because the AlN powder would become superficially oxidized. Preferable non-oxidizing ambient gases are nitrogen and argon. The heating temperature in the degreasing process is preferably 500° C. or more and 1000° C. or less. With temperatures of less than 500° C., surplus carbon is left remaining within the laminate following the degreasing process because the binder cannot sufficiently be eliminated, which interferes with sintering in the subsequent sintering step. On the other hand, at temperatures of more than 1000° C., the ability to eliminate oxygen from the oxidized coating superficially present on the surface of the AlN powder deteriorates, such that the amount of carbon left remaining is too little, degrading the thermal conductivity of the sinter.

The amount of carbon left remaining within the molded mass after the degreasing process is preferably 1.0 wt. % or less. If carbon in excess of 1.0 wt. % remains, it will interfere with the sintering, which would mean that ultrafine sinters could not be produced.

Next, sintering is carried out. The sintering is carried out within a non-oxidizing nitrogen, argon, or like atmosphere, at a temperature of 1700 to 2000° C. Therein the moisture contained in the ambient gas such as nitrogen that is employed is preferably −30° C. or less given in dew point. If it were to contain more moisture than this, the thermal conductivity of the sinter would likely be degraded, because the AlN would react with the moisture within the ambient gas during sintering and form nitrides. Another preferable condition is that the volume of oxygen within the ambient gas be 0.001 vol. % or less. A larger volume of oxygen would lead to a likelihood that the AlN would oxidize, impairing the sinter thermal conductivity.

As another condition during sintering, the jig employed is suitably a boron nitride (BN) molded part. Inasmuch as the jig as a BN molded part will be sufficiently heat resistant against the sintering temperatures, and superficially will have solid lubricity, when the laminate contracts during sintering, friction between the jig and the laminate will be lessened, which will enable sinters to be produced with little distortion.

The obtained sinter is subjected to processing according to requirements. In cases where a conductive paste is to be screen-printed onto the sinter in a succeeding step, the surface roughness is preferably 5 μm or less in Ra. If over 5 μm, in screen printing to form circuits, defects such as blotting or pinholes in the pattern are liable to arise. More suitable is a surface roughness of 1 μm or less in Ra.

In polishing to the abovementioned surface roughness, although cases in which both sides of the sinter are screen printed are a matter of course, even in cases where screen printing is effected on one side only the polishing process is best carried out on the face on the side opposite the screen-printing face. This is because polishing only the screen-printing face would mean that during screen printing, the sinter would be supported on the unpolished face, and in that situation burrs and debris would be present on the unpolished face, destabilizing the fixedness of the sinter such that the circuit pattern by the screen printing might not be drawn well.

Furthermore, at this point the thickness uniformity (parallelism) between the processed faces is preferably 0.5 mm or less. Thickness uniformity exceeding 0.5 mm can lead to large fluctuations in the thickness of the conductive paste during screen printing. Particularly suitable is a thickness uniformity of 0.1 mm or less. Another preferable condition is that the planarity of the screen-printing face be 0.5 mm or less. If the planarity exceeds 0.5 mm, in that case too there can be large fluctuations in the thickness of the conductive paste during screen printing. Particularly suitable is a planarity of 0.1 mm or less.

Screen printing is used to spread a conductive paste and form the electrical circuits onto a sinter having undergone the polishing process. The conductive paste can be obtained by mixing together with a metal powder an oxide powder, a binder, and a solvent according to requirements. The metal powder is preferably tungsten (W), molybdenum (Mo) or tantalum (Ta), since their thermal expansion coefficients match those of ceramics.

Adding the oxide powder to the conductive paste is also to enhance the strength with which it bonds to AlN. The oxide powder preferably is an oxide of Group IIa or Group IIIa elements, or is Al₂O₃, SiO₂, or a like oxide. Yttrium oxide is especially preferable because it has very good wettability with AlN. The amount of such oxides added is preferably 0.1 to 30 wt. %. If the amount is less than 0.1 wt. %, the bonding strength between AlN and the metal layer being the circuit that has been formed deteriorates. On the other hand, amounts in excess of 30 wt. % make the electrical resistance of the circuit metal layer high.

The metal powder may also have as its main constituent one or more selected from silver, vanadium and platinum. Ag system metals such as Ag—Pd or Ag—Pt are, to be specific, preferable. In that case the electrical resistance can be controlled by adjusting the content of the vanadium (Pd) or platinum (Pt). Oxide powder can also be added, likewise as the case with the tungsten, etc. In this case, the amount added of such oxides is preferably 1 wt. % or more, 30 wt. % or less.

A predetermined circuit pattern is fashioned by screen printing a paste prepared by mixing the metal powders together and adding a binder and a solvent. Therein, the thickness of the conductive paste is preferably 5 μm or more and 100 μm or less in terms of it post-drying thickness. If the thickness were less than 5 μm the electrical resistance would be too high and the bonding strength decline. Likewise, if in excess of 100 μm the bonding strength would deteriorate in that case too.

Also preferable is that in the patterns for the circuits that are formed, in the case of the heater circuit (resistive heating element circuit), the pattern spacing be 0.1 mm or more. With a spacing of less than 0.1 mm, shorting will occur when current flows in the resistive heating element and, depending on the applied voltage and the temperature, leakage current is generated. Particularly in cases where the circuit is employed at temperatures of 500° C. or more, the pattern spacing preferably should be 1 mm or more; more preferable still is that it be 3 mm or more.

After the conductive paste is degreased, baking follows. Degreasing is carried out within a non-oxidizing nitrogen, argon, or like atmosphere. The degreasing temperature is preferably 500° C. or more. At less than 500° C., elimination of the binder from the conductive paste is inadequate, leaving behind carbon in the metal layer that during baking will form carbides with the metal and consequently raise the electrical resistance of the metal layer.

The baking is suitably done within a non-oxidizing nitrogen, argon, or like atmosphere at, in the case of W, Mo or Ta, a temperature of 1500° C. or more. At temperatures of less than 1500° C., the post-baking electrical resistance of the metal layer turns out too high because the baking of the metal powder within the paste does not proceed to the grain growth stage. A further baking parameter is that the baking temperature should not surpass the firing temperature of the ceramic produced. If the conductive paste is baked at a temperature beyond the firing temperature of the ceramic, dispersive volatilization of the sintering promoter incorporated within the ceramic sets in, and moreover, grain growth in the metal powder within the conductive paste is accelerated, impairing the bonding strength between the ceramic and the metal layer.

In the case of Ag-system metals, furthermore, the baking temperature is preferably 700° C. to 1000° C. As far as the baking atmosphere is concerned, the baking can be carried out in air or in nitrogen. In this case the foregoing degreasing process can be omitted.

If the baking temperature is made high, the porosity of the electrical circuitry is decreased; it becomes greater if the baking is done at a lower temperature. Moreover, the porosity can also be adjusted depending on the amount of the binder and solvent added. Irrespective of the way in which the porosity is adjusted, effects according to the present invention are not influenced.

In order to ensure that the metal layer is electrically isolated, an insulative coating can be formed on the metal layer. Preferably the insulative coating substance is the same substance as the ceramic on which the metal layer is formed. Problems such as post-sintering warpage arising from the difference in thermal expansion coefficient will occur if the ceramic and insulative coating substances differ significantly. For example, in a case where the ceramic is AlN, a predetermined amount of an oxide/carbide of a Group IIa element or a Group IIIa element can be added to and mixed together with AlN powder, a binder and a solvent added and the mixture rendered into a paste, and the paste can be screen-printed to spread it onto the metal layer.

In that case, the amount of sintering promoter added preferably is 0.01 wt. % or more. With an amount less than 0.01 wt. % the insulative coating does not densify, making it difficult to secure electrical isolation of the metal layer. It is further preferable that the amount of sintering promoter not exceed 20 wt. %. Surpassing 30 wt. % leads to excess sintering promoter invading the metal layer, which can end up altering the metal-layer electrical resistance. Although not particularly limited, the spreading thickness preferably is 5 μm or more. This is because securing electrical isolation proves to be problematic at less than 5 μm.

Further according to the present method, the ceramic as substrates can be laminated according to requirements. Lamination may be done via an adhesive agent. The adhesive agent—being a compound of Group IIa or Group IIIa elements, and a binder and solvent, added to an aluminum oxide powder or aluminum nitride powder and made into a paste—is spread onto the bonding surface by a technique such as screen printing. The thickness of the applied adhesive agent is not particularly restricted, but preferably is 5 μm or more. Bonding defects such as pinholes and bonding irregularities are liable to arise in the adhesive layer with thicknesses of less than 5 μm.

The ceramic substrates onto which the adhesive agent has been spread are degreased within a non-oxidizing atmosphere at a temperature of 500° C. or more. The ceramic substrates are thereafter bonded to one another by stacking the ceramic substrates together, applying a predetermined load to the stack, and heating it within a non-oxidizing atmosphere. The load preferably is 0.05 kg/cm² or more. With loads of less than 0.05 kg/cm² sufficient adhesive strength will not be obtained, and otherwise defects in the joint will likely occur.

Although the heating temperature for bonding is not particularly restricted as long as it is a temperature at which the ceramic substrates adequately bond to one another via the adhesive layers, preferably it is 1500° C. or more. At less than 1500° C. adequate adhesive strength proves difficult to gain, such that defects in the bond are liable to arise. Nitrogen or argon is preferably employed for the non-oxidizing atmosphere during the degreasing and boding just discussed.

A ceramic laminated sinter that serves as a wafer holder thus can be produced as in the foregoing. As far as the electrical circuits are concerned, it should be understood that if they are heater circuits for example, then a molybdenum coil can be utilized, and in the electrostatic-chuck electrode and RF electrode cases, molybdenum or tungsten mesh can be, without employing conductive paste.

In this case, the molybdenum coil or the mesh can be built into the AlN raw-material powder, and the wafer holder can be fabricated by hot pressing. While the temperature and atmosphere in the hot press may be on par with the AlN sintering temperature and atmosphere, the hot press desirably applies a pressure of 10 kg/cm² or more. With pressure of less than 10 kg/cm², the wafer holder might not exhibit its capabilities, because gaps arise between the AlN and the molybdenum coil or the mesh.

Co-firing will now be described. The earlier-described raw-material slurry is molded into a sheet by doctor-blading. The sheet-molding parameters are not particularly limited, but the post-drying thickness of the sheet advisably is 3 mm or less. The sheet thickness surpassing 3 mm leads to large shrinkage in the drying slurry, raising the probability that fissures will be generated in the sheet.

A metal layer of predetermined form that serves as an electrical circuit is formed onto the abovementioned sheet using a technique such as screen printing to spread onto it a conductive paste. The conductive paste utilized can be the same as that which was descried under the post-metallization method. Nevertheless, not adding an oxide powder to the conductive paste does not hinder the co-firing method.

Subsequently, sheets that have undergone circuit formation are laminated with sheets that have not. Lamination is by setting the sheets each into position to stack them together. Therein, according to requirements, a solvent is spread on between sheets. In the stacked state, the sheets are heated as may be necessary. In cases where the stack is heated, the heating temperature is preferably 150° C. or less. Heating to temperatures in excess of this greatly deforms the laminated sheets. Pressure is then applied to the stacked-together sheets to unitize them. The applied pressure is preferably within a range of from 1 to 100 MPa. At pressures less than 1 MPa, the sheets are not adequately unitized and can peel apart during subsequent processes. Likewise, if pressure in excess of 100 MPa is applied, the extent to which the sheets deform becomes too great.

This laminate undergoes a degreasing process as well as sintering, in the same way was with the post-metallization method described earlier. Parameters such as the temperature in degreasing and sintering and the amount of carbon are the same as with post-metallization. In the previously described screen printing of a conductive paste onto sheets, a wafer holder having a plurality of electrical circuits can be readily fabricated by printing heater circuits, electrostatic-chuck electrodes, etc. respectively onto a plurality of sheets and laminating them. In this way a ceramic laminated sinter that serves as a wafer holder can be produced.

The obtained ceramic laminated sinter is subject to processing according to requirements. Routinely with semiconductor manufacturing devices, in the sintered state the ceramic laminated sinter often cannot be gotten into the precision demanded. The planarity of the wafer-carrying surface as an example of processing precision is preferably 0.5 mm or less; moreover 0.1 mm or less is particularly preferable. The planarity surpassing 0.5 mm is apt to give rise to gaps between the wafer and the wafer holder, keeping the heat of the wafer holder from being uniformly transmitted to the wafer and making likely the generation of temperature irregularities in the wafer.

A further preferable condition is that the surface roughness of the wafer-carrying surface be 5 μm in Ra. If the roughness is over 5 μm in Ra, grains loosened from the AlN due to friction between the wafer holder and the wafer can grow numerous. Particles loosened in that case become contaminants that have a negative effect on processes, such as film deposition and etching, on the wafer. Furthermore, then, a surface roughness of 1 μm or less in Ra is ideal.

A wafer holder base part can thus be fabricated as in the foregoing. Furthermore, a shaft is attached to the wafer holder. Although the shaft substance is not particularly limited as long as its thermal expansion coefficient is not appreciably different from that of the wafer-holder ceramic, the difference in thermal expansion coefficient between the shaft substance and the wafer holder preferably is 5×10⁻⁶ K or less.

If the difference in thermal expansion coefficient exceeds 5×10⁻⁶ K, cracks can arise adjacent the joint between the wafer holder and the shaft when it is being attached; but even if cracks do not arise when the two are joined, splitting and cracking can occur in the joint in that it is put through heating cycling in the course of being repeatedly used. For cases in which the wafer holder is AlN, for example, the shaft substance is optimally AlN; but silicon nitride, silicon carbide, or mullite can be used.

Mounting is joining via an adhesive layer. The adhesive layer constituents preferably are composed of AlN and Al₂O₃, as well as rare-earth oxides. These constituents are preferable because of their favorable wettability with ceramics such as the AlN that is the substance of the wafer holder and the shaft, which makes the joint strength relatively high, and readily produces a gastight joint surface.

The planarity of the respective joining faces of the shaft and wafer holder to be joined preferably is 0.5 mm or less. Planarity greater than this makes gaps liable to occur in the joining faces, impeding the production of a joint having adequate gastightness. A planarity of 0.1 mm or less is more suitable. Here, still more suitable is a planarity of the wafer holder joining faces of 0.02 mm or less. Likewise, the surface of the respective joining faces preferably is 5 μm or less in Ra. Surface roughness exceeding this would then also mean that gaps are liable to occur in the joining faces. A surface roughness of 1 μm or less in Ra is still more suitable.

Subsequently, electrodes are attached to the wafer holder. The attaching can be done according to publicly known techniques. For example, the side of the wafer holder opposite its wafer-retaining face, may be spot faced through to the electrical circuits, and metallization carried out on the circuit, or without metallizing, electrodes of molybdenum, tungsten, etc. may be connected to it directly using an active metal brazing material. The electrodes can thereafter be plated as needed to improve their resistance to oxidation. In this way, a wafer holder for semiconductor manufacturing devices can be fabricated.

Moreover, semiconductor wafers can be processed on a wafer holder according to the present invention, assembled into a semiconductor manufacturing device. Inasmuch as incidence of warping and cracking when heating is kept under control, manufacturing conditions are stabilized, making better-throughput processing of semiconductor wafers possible. Keeping warping and cracking under control makes it possible to gain stabilized characteristics in terms of the films formed and the heating processes.

### EMBODIMENTS

### Embodiment 1

A slurry was prepared by mixing 99 parts by weight aluminum nitride powder and 1 part by weight Y₂O₃ powder, and blending into the mixture 10 parts by weight polyvinyl butyral as a binder and 5 parts by weight dibutyl phthalate as a solvent. Here, an aluminum nitride powder having a mean particle diameter of 0.6 μm and a specific surface area of 3.4 m²/g was utilized. The slurry was rendered into granules using a spray dryer; and the granules were inserted into a mold and molded, degreased at 850° C., and then sintered at 1900° C. Here the atmosphere when degreasing and sintering was made a nitrogen atmosphere. The top and bottom sides as well as the perimeter of the sinters were processed to produce 345 mm outer diameter, 5 mm thickness AlN sinters.

In addition, a tungsten paste was prepared by adding ethyl cellulose as a binder and butyl Carbitol™ as a solvent to, and mixing together with: 98.8 weight % of a tungsten powder whose mean particle diameter was 2.0 μm, 0.6 weight % Y₂O₃, and 0.6 weight % Al₂O₃. A pot mill and a triple-roller mill were used for mixing. This tungsten paste was formed into a pattern for a heater circuit by screen-printing the paste onto the AlN sinters.

Electrical circuits of differing porosity were prepared by degreasing at 800° C. under a nitrogen atmosphere the AlN sinters printed with the heater circuits, and then baking them at temperatures of from 1800° C. to 1900° C. as set forth in Table I. Wafer holders were prepared by stacking a plurality of layers of AlN sinters not fashioned with electrical circuitry on the AlN sinters on which the heater circuit was formed, and laminating the stack together using a Al2O3-Y₂O₃—AlN as a bonding agent. A polishing process was performed on the wafer-retaining face of the wafer holders so that it would be 1 μm or less in Ra, and on the shaft-joining face so that it would be 5 μm or less in Ra. The wafer holders were also processed to true their outer diameter. The dimensions of the post-processing wafer holders were 340 mm outside diameter and 16 mm thickness.

A shaft made of AlN, 80 mm in outside diameter, 60 mm inside diameter, and 300 mm in length was then mounted onto the face on the side of the wafer holders opposite the wafer-retaining face. The bonding agent was 50% Al₂O₃-30% Y₂O₃-20% AlN.

The heater circuits in the wafer holders were partially exposed by spot-facing through the surface on the side opposite the wafer-retaining face, up to the heater circuit. Electrodes made of molybdenum were connected directly to the exposed portions of the heater circuits utilizing an active metal brazing material. The wafer holders were heated by passing current through the electrodes, and the isothermal ratings and change in the form of the wafer holders were measured.

Measurement of isothermal ratings was by setting a 12-inch wafer temperature gauge on the wafer-retaining faces and measuring the difference between the maximum and minimum temperatures. At that time, the power was adjusted so that the maximum temperature of the wafer temperature gauge would be 700° C. In addition, for change in form the wafer holders, not carrying the wafer temperature gauge, were heated to 700° C. and the difference in height (displacement differential) between the center and the periphery of the wafer-retaining face was measured using a laser displacement meter. Measurement also of the porosity of the heater circuits that were the electrical circuitry was carried out by slicing through the heater circuits, and observing the cross-sections with an electron microscope under 2000× magnification. The results are set forth in Table I.

TABLE I

| | Bake temp. | Pore proportion | Temp. diff. | Displacement |
|---|---|---|---|---|
| No. | (° C.) | (%) | (° C.) | (μm) |
| 1 | 1800 | 2.0 | 6 | 70 |
| 2 | 1850 | 0.5 | 8 | 80 |
| 3 | 1870 | 0.1 | 14 | 95 |
| 4 | 1900 | 0.05 | 21 | 120 |

In every one of the test samples, with respect to the center of the wafer-retaining face the periphery was high—i.e., the wafer-retaining face deformed into a concave shape—and the wafer temperature gauge temperature for the center was lowest.

### Embodiment 2

Wafer holders made of AlN, 340 mm outside diameter and 16 mm thickness, were prepared in the same manner as in Embodiment 1. Either molybdenum (Mo) paste or tantalum (Ta) paste was utilized, however, for the heater circuits that were the electrical circuitry. The oxides, binder and solvent within the pastes were made likewise as with Embodiment 1. The heater-circuit porosity, the temperature differential at 700° C., and the displacement were measured in the same manner as in Embodiment 1. The results are set forth in Table II.

TABLE II

| | | Bake | | Temp. | |
|---|---|---|---|---|---|
| | Heater-circuit | temp. | Pore | diff. | Displacement |
| No. | substance | (° C.) | proportion (%) | (° C.) | (μm) |
| 5 | Mo | 1800 | 1.9 | 7 | 75 |
| 6 | Mo | 1840 | 0.4 | 9 | 85 |
| 7 | Mo | 1860 | 0.1 | 14 | 95 |
| 8 | Mo | 1890 | 0.03 | 25 | 130 |
| 9 | Ta | 1800 | 2.0 | 7 | 75 |
| 10 | Ta | 1840 | 0.6 | 10 | 85 |
| 11 | Ta | 1860 | 0.2 | 16 | 100 |
| 12 | Ta | 1880 | 0.04 | 30 | 145 |

As is evident from Tables I and II, in cases in which W, Mo or Ta was utilized for the electrical circuitry, if the porosity of the circuitry was made 0.1% or more, displacement exceeding 100 μm did not appear in the wafer holders, even heated to 700° C., and the temperature differential was within 20° C. But with porosity of less than 0.1%, displacement differentials exceeding 100 μm occurred; moreover, the temperature differentials were large, exceeding 20° C., such that uniform temperature distribution could not be obtained.

### Embodiment 3

Wafer holders made of AlN, 340 mm outside diameter and 16 mm thickness, were prepared in the same manner as in Embodiment 1. Either 90 weight % Ag-10 weight % Pd (substance A) or 92 weight % Ag-8 weight % Pt (substance B) was utilized, however, for the heater circuits; and the heater-circuit baking temperature was varied from 850° C. to 900° C. as set forth in Table III. The porosity, the temperature differential at 500° C., and the displacement were measured in the same manner as in Embodiment 1. The results are set forth in Table III.

TABLE III

| | | Bake | Pore | | |
|---|---|---|---|---|---|
| | Heater-circuit | temp. | proportion | Temp. diff. | Displacement |
| No. | substance | (° C.) | (%) | (° C.) | (μm) |
| 13 | A | 850 | 5.0 | 3 | 40 |
| 14 | A | 870 | 2.2 | 7 | 80 |
| 15 | A | 890 | 1.6 | 13 | 115 |
| 16 | B | 850 | 3.9 | 4 | 55 |
| 17 | B | 870 | 2.0 | 6 | 75 |
| 18 | B | 890 | 1.5 | 12 | 105 |

As is evident from Table III, in cases in which an Ag-system metal was utilized for the electrical circuitry, if the porosity of the circuitry was made 2% or more, significant deformation in the wafer holders when heated did not occur, and uniform temperature distribution could be obtained. But it was clear that in cases in which the porosity was less than 2.0%, deformation became appreciable and temperature distribution proved to be large.

### Embodiment 4

Wafer holders No. 1 and No. 4 of Embodiment 1 were installed into film-deposition equipment, wherein tungsten films were deposited onto 12-inch silicon wafers. The result was that while in the case in which wafer holder No. 1 was utilized, fluctuation in the thickness of the tungsten film was a favorable 10% or less, in the case in which No. 4 was utilized, the fluctuation in the thickness of the tungsten film was a poor 20% approximately.

According to the present invention as given in the foregoing, in a wafer holder having a wafer-carrying surface, an electrical circuit layer consisting of one or more sinter laminae is formed on the face or in the interior of the wafer holder; and by rendering pores present in the circuit layer, the wafer holder can be made so that deformation such as warping and cracking does not occur when the wafer holder is heated. Utilizing a wafer holder of this sort enables the realization of semiconductor manufacturing equipment superior in isothermal rating and stabilized in manufacturing conditions.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A method of manufacturing a semiconductor device-fabrication wafer holder, the method comprising steps of:
preparing an insulative ceramic sinter as a wafer-holder substrate component;
polishing at least one of the substrate component's sides so as to render it a screen-printing face;
preparing a metal paste having as its main constituent one or more metals selected from tungsten, molybdenum and tantalum;
screen-printing the metal paste as a circuit lamina onto the screen-printing face of the wafer-holder substrate component; and
baking the wafer-holder substrate component at a temperature predetermined to control the porosity of the screen-printed circuit lamina to be from 0.1% to 40%.

2. A method of manufacturing a semiconductor device-fabrication wafer holder, the method comprising steps of:
preparing an insulative ceramic sinter as a wafer-holder substrate component;
polishing at least one of the substrate component's sides so as to render it a screen-printing face;
preparing a metal paste having as its main constituent one or more metals selected from silver, vanadium and platinum;
screen-printing the metal paste as a circuit lamina onto the screen-printing face of the wafer-holder substrate component; and
baking the wafer-holder substrate component at a temperature predetermined to control the porosity of the screen-printed circuit lamina to be from 2% to 40%.

3. A wafer-holder manufacturing method as set forth in claim 1, wherein said circuit lamina constitutes any one of an electrode circuit for an electrostatic chuck, a resistive-heating-element circuit, an RF-power electrode circuit, and a high-voltage-generating electrode circuit.

4. A wafer-holder manufacturing method as set forth in claim 2, wherein said circuit lamina constitutes any one of an electrode circuit for an electrostatic chuck, a resistive-heating-element circuit, an RF-power electrode circuit, and a high-voltage-generating electrode circuit.

5. A wafer-holder manufacturing method as set forth in claim 1, further comprising a step of:
repeating said wafer-holder substrate component preparation step to form a plurality of substrate component sinters, and laminating the component sinters together with the wafer-holder substrate component onto which the circuit lamina has been screen printed, so as to form a single-ply, laminar circuit on or in a multilaminate sandwich of insulative ceramic sinter sheets.

6. A wafer-holder manufacturing method as set forth in claim 1, further comprising a step of:
repeating said wafer-holder substrate component preparation step, said screen-printing step, and said baking step so as to form a multilaminate circuit layer constituted by a multi-ply sandwich of single-ply, laminar circuits in between which insulative ceramic sinter sheets are interleaved.

7. A wafer-holder manufacturing method as set forth in claim 2, further comprising a step of:
repeating said wafer-holder substrate component preparation step to form a plurality of substrate component sinters, and laminating the component sinters together with the wafer-holder substrate component onto which the circuit lamina has been screen printed, so as to form a single-ply, laminar circuit on or in a multilaminate sandwich of insulative ceramic sinter sheets.

8. A wafer-holder manufacturing method as set forth in claim 2, further comprising a step of:
repeating said wafer-holder substrate component preparation step, said screen-printing step, and said baking step so as to form a multilaminate circuit layer constituted by a multi-ply sandwich of single-ply, laminar circuits in between which insulative ceramic sinter sheets are interleaved.

9. A wafer-holder manufacturing method as set forth in claim 1, wherein in said step of preparing the metal paste, proportions of paste-constituent binder and solvent are adjusted so that, together with the predetermined baking temperature in said baking step, the porosity of the screen-printed circuit lamina is controlled to be within said range.

10. A wafer-holder manufacturing method as set forth in claim 2, wherein in said step of preparing the metal paste, proportions of paste-constituent binder and solvent are adjusted so that, together with the predetermined baking temperature in said baking step, the porosity of the screen-printed circuit lamina is controlled to be within said range.
